(19) United States
(12) Patent Application Publication
(10) Pub. No.: US 2014/0279793 A1
(43) Pub. Date: Sep. 18, 2014

(54) SYSTEMS AND METHODS FOR PROVIDING RELEVANT PATHWAYS THROUGH LINKED INFORMATION

(71) Applicant: Balderdash Inc., Dallas, TX (US)

(72) Inventor: Justin Wohlstadter, Dallas, TX (US)

(21) Appl. No.: 14/209,103

(22) Filed: Mar. 13, 2014

Related U.S. Application Data
(60) Provisional application No. 61/782,656, filed on Mar. 14, 2013.

(51) Int. Cl. G06N 5/04

(52) U.S. Cl. CPC G06N 5/04
USPC 706/46

(57) ABSTRACT

Systems and methods for predicting and monetizing information pathways. An indication is received that a user has visited a webpage and, based on information associated with the visit, a predictive model is used to predict a plurality of webpages that are likely to be visited by the user. The user is then provided with a subset of the predicted webpages as a traversable pathway of webpages. Information relating to the user's traversal of the pathway can be collected and used to facilitate the provision of an advertisement to the user.

### CROSS-REFERENCE TO RELATED APPLICATION

This application claims priority to and the benefit of U.S. provisional patent application 61/782,656, filed on Mar. 14, 2013, and entitled “Interface for Recording and Displaying Pathways Through Linked Information,” the entirety of which is incorporated by reference herein.

### BACKGROUND

Over the last twenty years, the methods used to gather, store and research information have changed dramatically. While computer systems had been in use for many years prior, not until the development and deployment of a simple, platform-independent application with which consumers gain access to the vast amount of information did the Internet and World Wide Web become an integral part of daily life. Early versions of web browsers allowed users to access files, view text and follow links from one “site” (usually simply a directory on a server) to another. Subsequent applications, such as Mosaic, supported the integration of images and other non-text content into web pages. Over time, browsers became more complex, allowing for full-experience multimedia through Flash and HTML5, structured documents data using XML and JSON, personalized browsing through cookies, interactive applications through JavaScript and AJAX, and much more. The functionality of computer-resident browsers has, more recently, been expanded to include mobile devices, tablets, and other non-traditional devices on which consumers now expect to search and access information.

In print media, content is laid out in a sequential fashion, implying a single, linear reading order. When a person reads a book, there is no fear of missing a critical piece of information, or not understanding the material due to reading order because it is understood that the book will always be read from front to back, with each page following the next. On the web, and in other multi-nodal networks with linked content, hyperlinks provide a way to consume content in a non-linear fashion, as every link provides a jumping point to a connected piece of content, with no specific ordering. In this environment, understanding the possible ways of moving through connected pieces of information is critical. There is currently no mechanism to view potential pathways through linked information, or how others have traversed this linked information previously.

Web browsers today record and display browsing history as a chronological list, which only provides insights into the time when a user arrived at a page, neglecting crucial information about how that page visit related to the pages that were viewed before and afterward. In a single window, storing and displaying page visits in a simple chronological list is a correct and complete way of describing a progression through a series of pages, but with the advent of tabbed browsing, the browser experience is distributed across multiple parallel browsing environments, each with their own local browsing history. In this context a single chronological list is no longer useful for understanding browsing history in general, and browsing history specific to each environment and among environments.

For example, if a user opens Tab 1 and moves from Page A to Page B via a link on Page A, and then opens a Tab 2 and moves from Page C to Page D via a link on Page C, and then goes back to Tab 1 and clicks a link to move from Page B to Page E, the user's browser history will display the following pages visited in order from latest to earliest: E>D>C>B>A. This implies that the user arrived at Page E from Page D, whereas the actual order was E>B, D>C, B>A. Current browsers have no mechanism for explicitly recording and visualizing these relationships in web and other linked information browsers, providing little or no understanding of the sequential relationship between the linked information as it was viewed.

Moreover, most users do not operate using the browser's “time-stamp” for a given page visit, meaning users do not remember what pages or content they viewed based solely on a specific time of day. Therefore, finding pieces of information they viewed in the past is difficult. Some browsers allow for text search of the content of historical pages, but even that becomes a guessing game of what words were in a piece of content. There is unfortunately no way to find previously viewed content based on the sensory information that humans use to naturally store and recall data, such as location, temperature, weather, companions, etc.

### BRIEF SUMMARY

Systems and methods are presented for predicting and monetizing information pathways. In one aspect, a computer-implemented method includes receiving an indication that a user has visited a webpage; predicting, using a predictive model, a plurality of webpages that are likely to be visited by the user, the prediction based at least in part on information associated with the visit to the webpage; and providing a subset of the predicted webpages to the user as a traversable pathway of webpages.

In one implementation, predicting the webpages that are likely to be visited by the user includes determining an intent of the user based on the information associated with the visit to the webpage.

In another implementation, the information associated with the visit to the webpage includes at least one of: content of the visited webpage, a URL of the visited webpage, a link graph related to the visited webpage, a publisher associated with the visited webpage, and an author associated with the visited webpage. The information associated with the visit to the webpage can also include at least one of: a demographic of the user, a geolocation of the user, a behavior pattern of the user, a preference of the user, and social networking information associated with the user. The information associated with the visit to the webpage can also include at least one of: open browser tabs, previous webpages visited, webpages the user is likely to visit, and a pathway to the visited webpage. The information associated with the visit to the webpage can also include at least one of: a user action on the visited webpage, a user action with respect to the pathway, a duration of a user action on the visited webpage, and a duration of a user action with respect to the pathway. The information associated with the visit to the webpage can also include at least one of: a current date, a current time, nearby or tethered devices to a device of the user, active applications on a device of the user, current weather, a current event, and a calendar event.

In a further implementation, providing the subset of predicted webpages includes ranking, using a ranking model, the webpages that are likely to be of interest to the user, and wherein the subset of predicted webpages comprises webpages that are highly ranked based on the ranking model.

In yet another implementation, the pathway includes a plurality of webpages relating to a topic of interest to the user. The pathway can also include a set of webpages preselected by another user, and/or a set of webpages automatically selected based at least in part on the information associated with the visit to the webpage.

In one implementation, the method further includes crawling a plurality of webpages, and the prediction is further based at least in part on information associated with the crawled webpages. The method can further include facilitating the provision of an advertisement to the user based on one or more of the webpages that are likely to be visited by the user. The advertisement can be provided to the user in the course of a traversal of the pathway by the user.

In another aspect, a system includes one or more computers programmed to perform operations including receiving an indication that a user has visited a webpage; predicting, using a predictive model, a plurality of webpages that are likely to be visited by the user, the prediction based at least in part on information associated with the visit to the webpage; and providing a subset of the predicted webpages to the user as a traversable pathway of webpages.

In one implementation, predicting the webpages that are likely to be visited by the user includes determining an intent of the user based on the information associated with the visit to the webpage.

In another implementation, the information associated with the visit to the webpage includes at least one of: content of the visited webpage, a URL of the visited webpage, a link graph related to the visited webpage, a publisher associated with the visited webpage, and an author associated with the visited webpage. The information associated with the visit to the webpage can also include at least one of: a demographic of the user, a geolocation of the user, a behavior pattern of the user, a preference of the user, and social networking information associated with the user. The information associated with the visit to the webpage can also include at least one of: open browser tabs, previous webpages visited, webpages the user is likely to visit, and a pathway to the visited webpage. The information associated with the visit to the webpage can also include at least one of: a user action on the visited webpage, a user action with respect to the pathway, a duration of a user action on the visited webpage, and a duration of a user action with respect to the pathway. The information associated with the visit to the webpage can also include at least one of: a current date, a current time, nearby or tethered devices to a device of the user, active applications on a device of the user, current weather, a current event, and a calendar event.

In a further implementation, providing the subset of predicted webpages includes ranking, using a ranking model, the webpages that are likely to be of interest to the user, and wherein the subset of predicted webpages comprises webpages that are highly ranked based on the ranking model.

In yet another implementation, the pathway includes a plurality of webpages relating to a topic of interest to the user. The pathway can also include a set of webpages preselected by another user, and/or a set of webpages automatically selected based at least in part on the information associated with the visit to the webpage.

In one implementation, the operations further include crawling a plurality of webpages, and the prediction is further based at least in part on information associated with the crawled webpages. The operations can further include facilitating the provision of an advertisement to the user based on one or more of the webpages that are likely to be visited by the user. The advertisement can be provided to the user in the course of a traversal of the pathway by the user.

In one aspect, a computer-implemented method includes providing a traversable pathway of webpages to a user; collecting information relating to a traversal of the pathway by the user; and facilitating the provision of an advertisement to the user based at least in part on the collected information.

In one implementation, the traversable pathway is provided to the user based on a prediction of webpages that the user is likely to visit. The advertisement can be provided to the user based at least in part on the predicted webpages.

In another implementation, the collected information includes at least one of: content of the visited webpage, a URL of the visited webpage, a link graph related to the visited webpage, a publisher associated with the visited webpage, and an author associated with the visited webpage. The collected information can also include at least one of: a demographic of the user, a geolocation of the user, a behavior pattern of the user, a preference of the user, and social networking information associated with the user. The collected information can also include at least one of: open browser tabs, previous webpages visited, webpages the user is likely to visit, and a pathway to the visited webpage. The collected information can also include at least one of: a user action on the visited webpage, a user action with respect to the pathway, a duration of a user action on the visited webpage, and a duration of a user action with respect to the pathway. The collected information can also include at least one of: a current date, a current time, nearby or tethered devices to a device of the user, active applications on a device of the user, current weather, a current event, and a calendar event.

In a further implementation, facilitating the provision of an advertisement includes providing the collected information to one or more advertisers for targeting the advertisement to the user.

In yet another implementation, facilitating the provision of an advertisement to the user comprises inserting the advertisement between two webpages in the pathway. The pathway can be sponsored by an advertiser and/or can include branded content.

In another aspect, a system includes one or more computers programmed to perform operations including providing a traversable pathway of webpages to a user; collecting information relating to a traversal of the pathway by the user; and facilitating the provision of an advertisement to the user based at least in part on the collected information.

In one implementation, the traversable pathway is provided to the user based on a prediction of webpages that the user is likely to visit. The advertisement can be provided to the user based at least in part on the predicted webpages.

In another implementation, the collected information includes at least one of: content of the visited webpage, a URL of the visited webpage, a link graph related to the visited webpage, a publisher associated with the visited webpage, and an author associated with the visited webpage. The collected information can also include at least one of: a demographic of the user, a geolocation of the user, a behavior pattern of the user, a preference of the user, and social networking information associated with the user. The collected information can also include at least one of: open browser tabs, previous webpages visited, webpages the user is likely to visit, and a pathway to the visited webpage. The collected information can also include at least one of: a user action on the visited webpage, a user action with respect to the pathway, a duration of a user action on the visited webpage, and a duration of a user action with respect to the pathway. The collected information can also include at least one of: a current date, a current time, nearby or tethered devices to a device of the user, active applications on a device of the user, current weather, a current event, and a calendar event.

In a further implementation, facilitating the provision of an advertisement includes providing the collected information to one or more advertisers for targeting the advertisement to the user.

In yet another implementation, facilitating the provision of an advertisement to the user comprises inserting the advertisement between two webpages in the pathway. The pathway can be sponsored by an advertiser and/or can include branded content.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a diagram of a high-level architecture and information inputs of a system according to an implementation.

FIG. 2 is a block diagram of a content and browser tracking system according to an implementation.

FIG. 3 is a screen capture illustrating a user's browsing pathway through linked data according to an implementation.

FIG. 4 is a screen capture illustrating a user's browsing pathway through linked data and associated metadata according to an implementation.

FIG. 5 is a screen capture illustrating multiple browsing pathways through linked data according to an implementation.

FIG. 6 is a file listing showing details of a user's browsing pathway through linked data annotated with contextual information according to an implementation.

FIG. 7 is a screen capture illustrating a pathway editing interface according to an implementation.

### DETAILED DESCRIPTION

Described herein in various implementations are systems and accompanying methods for providing a user with a traversable pathway of webpages (e.g., on the World Wide Web) or content on other online or offline information systems (e.g., LexisNexis, Westlaw), based on a prediction of what content the user is likely to engage with. As used herein, a “pathway” refers to a collection of individual content sources, such as webpages, that are presented as a linked, browseable route that a user can traverse. The pathway can be a single route, or can include multiple branching routes that a user can individually traverse and/or alternate among. The content sources in a pathway can be related in some manner; for example, they can share a similar topic or concept, be in a similar format, have the same or related author or publisher, and so on. The user can traverse a pathway one consecutive content source at a time, or can jump back and forth to any particular content source. Pathways can change dynamically as a user progresses through the content sources. For example, the present system can predict and present different content sources that the user is likely to traverse, or that are otherwise likely to be of interest to the user, based on various information relating to the user's traversal of the pathway and browsing of individual content sources.

There is currently no way to view pathways taken by a user (or potential pathways that a user can take) through linked content. Further, existing systems also lack a way the ability to sort and search content browsing history by circumstantial or contextual data (e.g., data outside the realm of the browser's operating environment). Having an understanding of how a user arrived at a certain piece of information and where the user went after viewing it (i.e., link context) makes it easier to find and understand the importance of that information. Further, having a mechanism to search and filter linked information based on parameters that are truly user-centric, that is, that they are not solely based on time and text, provides a much more natural way to remember and find previously consumed information. Being able to see alternate possible pathways through linked content, as well as pathways taken by other individuals relevant to the user or the subject matter is a powerful tool for curating a learning experience.

The terms user device, computer, and user are used interchangeably throughout, and refer not only to traditional desktop computers, but also include hand-held computing devices such as smartphones, tablet computers, televisions, gaming consoles, and personal data assistants, as well as displays embedded within appliances, automobiles, and other consumer goods. Implementations of the system can take various forms, including, but not limited to a standalone browsing application, an application that integrates with existing, installed browsing applications (also known as an “extension”), or an application embedded within websites (e.g., a widget, JavaScript code, etc.) that need not be installed on an individual user's device. Collectively, the stored computer instructions, when executed, are referred to herein as an “application.” In some implementations, the system includes one or more remote servers that communicate with the application and that provide information storage, analytic, and/or predictive functionality, as described herein.

FIG. 1 shows, at a high-level, the operation of one implementation of the system. A user browses information content on a user device 102. The application 106, which resides on the user device 102, collects information associated with the user's browser activity and provides suggested pathways to the user, as further described herein. Remote server 110 includes a webpage crawler 120, predictive model 130, ranking model 140, and data store 150. It is to be appreciated, however, that the functionality in remote server 110 can be provided in whole or in part by the application 106 on the user device 102.

In one implementation, the application 106 collects information that is available to a browser (e.g., a separate browser or a browser supplied with the application) as a user browses webpages or other content sources in a pathway or independently from a pathway (“user state information”) Referring to FIG. 1, the user's browsing activity is shown on timeline 160, over which the user browses from one page to the next in the direction shown. Examples of user state information can include, but are not limited to, which tab(s) a user had open when they visited a page, how they arrived at a page, if a redirect was involved, a site referrer, and previous pages visited.

The application 106 can also collect information that the application 106 captures on its own (“user action information”) to string together a record of how the user moved through pages of linked content, effectively building pathways through the data. User action information can include, for example, actions performed on a webpage (e.g., links clicked, cursor movements, clicks, gestures, text selections, videos or other media viewed, scroll speed, scroll position, etc.), a duration of a user action on a webpage (e.g., how long the user spent on a portion or all of the page, how long the user watched a video, etc.), a user action on the pathway (e.g., whether user browsed to or ignored suggested content on the pathway, which pages the user jumped back or forth to, etc.), and a duration of a user action with respect to the pathway (e.g., how quickly the user moves among content sources in the path, etc.).

The application 106 can also collect information about the user (“user profile information”) and combine it with other collected information. User profile information can include, but is not limited to, a demographic of the user (e.g., age, age range, sex, income range, etc.), a geolocation of the user, a behavior pattern of the user, a preference of the user (e.g., whether the user prefers certain types or forms of content, such as text or video, whether the user prefers brief, broad, and/or in-depth content, whether the user prefers certain publishers or authors, etc.), social networking information associated with the user (e.g., friends, contacts, tweets, posts, likes, dislikes, expertise, education, experience, etc.), and so on.

In some implementations, the application 106 can collect information relating to the content pages browsed by the user (“content source information”). Examples of the content source information can include the content of a webpage (e.g., analyzed using natural language processing, keyword or phrase recognition, etc.), the URL path of a webpage (e.g., if the URL contains “/politics,” it is likely that the webpage is related to a policy topic), link graphs related to a webpage (which pages link to the webpage and/or which pages the webpage links to—the graph can extend out one or more degrees of links inside and/or outside of a website), the webpage publisher (e.g., New York Times, Wikipedia, etc.), the webpage author, whether the webpage is a “hub” (i.e., whether the webpage is open-ended or includes many different topics, like a search results page or the home page of a news site, or is an endpoint relating to a specific topic, such as a news article, a product listing, etc.), and so on.

Contextual information that can be used to describe the environment and circumstances surrounding a given page visit can also be collected in conjunction with the user's browsing activity. Contextual information can include the current date, a locality, recognized nearby and/or tethered devices to the user's device 102, other active applications on the user's device 102, weather, current events, calendar events, phone calls, personal information, and so on. The contextual information can be collected locally by the application 106 on the user's device 102 and/or by a remote server 110, which can augment user state, user action, user profile, and/or content source information sent to the server 110 with the contextual information. The collected information can be stored in data store 150.

The remote server 110 can include a web crawler component 120 that collects information about webpages 125 on the World Wide Web, or other content sources. For example, some of the information described above, such as content source information and contextual information, can be collected with respect to pages 125 processed by the crawler 120. The webpages 125 processed by the crawler 120 can be categorized at a high-level as time-sensitive content (e.g., news articles) or evergreen content (e.g., history, educational articles), although other high-level categorizations are possible. The crawler 120 can process pages 125 randomly, by crawling links graphs starting from particular webpages, or by some other suitable manner.

The collected information relating the crawled webpages 125 can be stored in data store 150 for use by the remote server 110 in predicting webpages of interest for the user browsing pages on his device 102, as further described below. To facilitate the predictive process, the crawler 120 can create mappings of content publishers and pages to content categories for some or all of the pages it crawls. For example, Yelp can be mapped to “food,” New York Times politics can be mapped to “policy,” and Netflix can be mapped to “movies.” Some websites include groups of links (e.g., bit.ly bundles, Delicious) that include category tags for the links. The crawler 125 can intake the link groups and categories such that they are available to the predictive component of the system in determining webpages and pathways of interest to a user.

Other information relating to the crawled webpages 125 can be determined and used for categorization, such as content length, how well-written the content is, type of content, and so on. The importance of a page can also be useful to categorize the page, as well as to inform the predictive and/or ranking components of the system as to whether the page would be valuable to a user. The importance can be determined by, for example, the number of shares or likes of the page, links to the page, how many times the page has been selected, the uniqueness of the URL (i.e., whether many different URLs merely link to the same page), the quality of the publisher, and so on. Ultimately, the pages 125 processed by the crawler 120 can be used as potential building blocks in pathways provided to users, and the information collected about the crawled pages 125 can be used to determine and select relevant webpages for a pathway once a user's intent is identified.

The information collected while a user is browsing content, including contextual information and user intent, can be stored in a user profile for later reference by the system. In some implementations, the user is able to access his profile in order to edit what the system has determined are the user's interests, behaviors, habits, and so on.

Based on some or all of the information described above, the system can use one or more predictive models 130 to predict a set of content sources that the user would be likely to visit if he were to continue browsing. Of note, the system can use the collected information to determine the user's intent, that is, what the user is attempting to search for, to learn about, to peruse, and the like. For example, a user interested in reading about the symptoms and treatment for influenza can begin his search by entering these terms in a search engine. As the user browses several webpages returned by the search engine, the system can track, among other things, the content of the browsed pages (e.g., noting common keywords such as influenza, symptoms, cure, etc.), the link graphs related to the pages (e.g., identifying other interesting webpages in the graphs), the user's activity on each page (e.g., recognizing that the user spends most of his time on in-depth articles and skips through short summaries and videos), and the user's location (e.g., noting that the user is in the Northeast U.S. during flu season). Inputting this information into the predictive model 130, the system can predict a number of webpages that are likely to be preferable to the user in his browsing activity. This prediction can go beyond merely finding other webpages that refer to flu symptoms and treatment generally. Rather, the model can take all of the collected information into account to predict that the user would prefer to browse, for example, in-depth articles on flu symptoms and treatment that also refer to outbreaks of the flu near the user's location.

In some implementations, the predictive model 130 includes machine learning, pattern recognition, data mining, statistical correlation, and/or other suitable known techniques. In one example, the collected information described above relating to the user's browsing activity and the collected information relating to the crawled webpages 125 can each be viewed as vectors in a multi-dimensional space, and the similarity between relevant portions of information can be determined based on a cosine angle between vectors. As another example, a decision tree can be used in the predictive model 130 which maps observations of the foregoing collected information to determine whether particular items of information signify a particular conclusion (e.g., whether a user would likely browse a particular webpage based on the user's behavior patterns). In another example, sets of data including the foregoing collected information are correlated to determine a statistical relationship, or dependence. Using this technique, the system can, e.g., predict that a user is likely to browse articles having some relation to the user's general locality, rather than articles having a more global appeal.

With some machine learning techniques, a classifier (e.g., a suitable algorithm that categorizes new observations) can be trained over time using various collected information, such as user state information, user action information, user profile information, content source information, contextual information, crawled webpage information, and the like. Currently collected information can then be input to a classifier to allow the present system to make predictions about webpages that a user is likely to visit. The predictive model 130 can be trained to recognize the relationships between the various kinds of information and how such relationships tend to indicate which webpages a user will choose to browse. Then information that is collected about a user's activity while the user is browsing can be input into the trained classifier to obtain as output characteristics of particular webpages that would predictably interest a user. The system can then identify a set of webpages from the crawled webpages 125 that satisfy some or all of these characteristics. In some situations, if no relevant sources of content are identified, there will be no pages to provide in a pathway to the user or, alternatively, the system can provide random content to the user.

In one implementation, the set of identified webpages can number in the tens, the hundreds, the thousands, or more. For example, the system may identify approximately 1000 webpages that may be of interest to the user based on the user's current browsing activity, context, and/or other factors. The set of identified webpages can then be narrowed down into a shorter, coherent pathway (e.g., 2-3 pages, 5-10 pages, 15-20 pages, etc.) using a ranking model 140. The ranking model 140 can be used to rank the identified webpages so that a subset of the highest or highly ranked webpages can be provided to the user in a pathway.

The ranking model 140 can include machine learning, pattern recognition, data mining, statistical correlation, and/or other suitable known techniques. In one implementation, ranking is performed using term frequency-inverse document frequency (tf-idf) to determine the distribution and importance of terms in content on a webpage, and then considering this data in relation to topical categories that are of interest to the user and/or related to the user's browsing intent. The explicit and/or implicit importance of a webpage, determined as described above, can also be used as a factor in ranking pages (e.g., as a weighted factor). Other ranking techniques can include the training of a classifier to recognize pages that should be ranked more highly. For example, the classifier can be trained using the page importance data, data relating to which pages users have chosen to browse to the exception of others, and other relevant information. Information about the set of identified webpages, as well as information about the user and browsing activity, can then be input into the classifier to determine likelihoods (e.g., numerical probabilities) for each page that the user would be likely to browse the page to satisfy his intent.

Once the identified webpages are ranked by a suitable ranking model 140, a subset of highly or the highest ranked pages can be selected for provision to the user as a traversable pathway. The ranked pages that are selected and the ordering thereof can be based on various methods. For example, the top N highest ranked pages can be selected and presented in that order. In some implementations, a degree of randomness can be a factor in page selection; for example, one or more of the selected ranked pages can be randomly selected from the full set of ranked webpages or, e.g., the top 10%, 20% and so on. In other implementations, Markov chains or other state representations can be used to inform the selection and/or ordering of ranked pages. For example, complex Markov chains can be built based on historical collected information that represent the paths a user is most likely to take through a collection of webpages. The ranked pages can then be selected and ordered by choosing an initial webpage and following a particular chain.

In one implementation, the selection and ordering of the ranked pages can be influenced by the particular types or forms of content. For example, the resulting pathway can seek to “tell a story.” Returning to the influenza example, above, the first page in a pathway provided to the user can be a broad article describing influenza and the related symptoms. The next page in the pathway can be a video that explains various medical treatments for the flu. Another page in the pathway can be a forum site where people discuss home remedies. Thus, the system may not select the highest ranked pages, but may intelligently select pages that address the user's intent through different forms and subtopics of content, which can be based on the user's profile data.

Based on the user's traversal of a pathway and/or other separate webpages, the system can create and save a dynamic, or “synthetic,” pathway. Such pathways can be created by dividing the user's traversal of webpages into segments, with hubs acting as dividers, because the hubs will often signify that the user is branching off into a new topic. Hubs and pages that do not appear to be relevant to the user's determined intent can be ignored in creating one or more synthetic paths out of the segments.

In addition to synthetic pathways based on the user's browsing activity, the system can also provide the user with all or a portion of a preexisting pathway stored by the system in a pathway library 135. These preexisting pathways can be synthetic pathways that were created by the browsing activity of another user, or manually-created pathways created by a user through a pathway editing interface. Pathways, whether synthetic or manually-created, can be private (available only to the creating user or an identified group of users), or can be publicly available. Pathways that are made available to users, once identified as relevant by the predictive model 130, can also be ranked using the ranking model 140, such that the highest or a highly ranked relevant pathway (or portion thereof) can be provided to a user as described herein.

Once the pathway is constructed, the associated data can be sent to the application 106 to be displayed in a user interface. The data (individual pages and pathways) can be visualized within the main browsing window for the user, as well as in other expanded views that allow the user to manipulate pathways (e.g., remove, reorder, and add pages in the pathway), see potential pathways they can take, as well as share them with others. Newly-created pathways can also be stored in a library alongside future potential pathways that are generated based on the aggregated browsing patterns of a global community of users and/or the browsing behavior of the given user. These future potential pathways can evolve over time as user behavior changes, and content is added to or removed from the shallow (e.g., most frequented) web.

The pathways that are stored in the library 135 can be provided to others users if the system determines that the content of a particular pathway would be relevant to them. Specifically, in instances in which the application 106 records the browsing pathways traversed by its users, the pathways can be used to augment existing page recommendation methods to provide users with suggestions of series of sequential pages they can visit on the web relevant to their current location on the web, previously visited pages, and place that others have gone.

By aggregating this data across all users, the application 106 can be used to trace and present popular pathways originating from a given user's present page location. For example, suggesting a pathway comprised of the most common link clicked on the page currently in view and on each subsequent page in the resulting sequence. As described above, a user's contextual and relational browsing history can be used to better inform an understanding of the user's browsing behavior and preferences and as such, suggest pages and pathways originating from the user's present page location that the user may be most interested in.

In some implementations, the application 106 collects implicit feedback data and provides it to the server 110 for use by the predictive model 130 and/or ranking model 140 to cause dynamic modifications in a pathway that a user is browsing. Of note, for each additional page traversed by a user, there can be a reevaluation of the user's intent, and thereby potential changes to the suggested pages in a pathway provided to the user. Thus, in addition to the predictive model 130 and ranking model 140 considering the various collected information described above, the suggested pages can be further based on implicit feedback, such as whether a user accepts or browses to a recommended page in the pathway, whether a user skips particular content in the pathway, whether a user spends a time on particular content in the pathway and for how long, and so on. Feedback can be recursive; thus, the current dynamic pathway itself and individual pages within can be fed back to the models 130, 140 to find additional content that may be more relevant based on the user's current activities.

In one implementation, the application 106 can be installed on an Internet (or other, non-Internet) browser that both listens to browser events (i.e., activity that occurs within the browser such as tab creation, deletion, page loading, redirects, etc.), and provides for the injection of scripts into pages (e.g., by relaying pages through a proxy server) which are able to relay information about that page to location where the data is collected, stored, and reconciled. Once installed, the application 106 can set up “listeners,” or pieces of code that listen for certain browser activity, to record every time a browser instance is initiated, a tab is created, a tab is closed, a tab is moved, a navigation event occurs (either user generated or browser generated), the state of URL changes on a page (sometimes the URL of a page can change without the page itself reloading), and so on. The listeners are set to act in concert such that when a user moves from one URL to the next, either within the their current tab or a new tab, the application 106 is aware of all such activity. In addition to the new URL and tab ID, the listeners can provide information as to the type of transition that occurred on navigation (e.g., whether it was a typed URL or a link click), as well as the tab from which that transition came, if not the current tab, and any other activities that might have occurred in between, such as page redirects.

In one implementation, as illustrated in FIG. 2, upon a page being opened in a browser tab or window, an application inserts into the page a set of scripts that are able to record and relay information back to a persistent background script, which stores all of the aforementioned listener activity in memory, along with other data deemed important such that it will persist beyond a page or session. These scripts (“content scripts”) can record the page title, URL, and other information about the page including a copy of the entire content of the page itself, including all links, and relay that back to the background script for processing. Often times the browser listeners will not capture every single navigation event that occurs in the browser, and therefore it can be necessary to gather this information from other sources, such as the pages themselves, as a backup. The navigation information captured by the content scripts provides unique data that the browser itself often does not have access to (and requires special user permissions to capture), including the links on the page.

Once page data is captured, the background script takes the information it has gathered on a specific navigation event, and reconciles that with data captured from the page to determine what previous page within which active tab and in what browser window that navigation activity originated from. Often the data points captured from the browser itself include data from a “tabs” API provided by the browser that indicates the state of an open tab, a “history” API that gives information about the time and sequence of a browsing event related to other activity, and a “web navigation” API that relays information about the specific kind of transition that occurred (for example whether it was a client redirect or a server redirect). These data points are then reconciled with information sent from the content scripts about the page itself, such as the primary domain contained in the URL as well as the links on the page and data in the head element of the page that can provide categorization data as well to construct lists of links along a “pathway” that the user navigated along.

In some implementations, links scraped from the page itself can be used to reconstruct a navigation event if the browser fails to provide one itself. For example, a search on an Internet search engine produces a list of results with URLs to the desired pages. But upon clicking a URL, the search engine dynamically changes that URL to a transient intermediate URL used for internal tracking, that then forwards a user onto the desired page. Raw data provided by the browser would indicate that the user actually visited this intermediate URL when in fact the user never even observed it, and would interfere in the relational pathway disconnecting the search results page from the actual destination page. In addition, URL fragments (i.e., the segment of the URL that follows the domain) can be used to identify the source of a link and whether it originated from the same page or from a source external to the browser such as a link in an email. These fragments are often used by third parties to relay information to internal and external systems and can be captured and used in our sorting and linking process.

Further reconciliation of pathways can be done using previously recorded user behavior from these two capture mechanisms. In some cases users will often journey from one similar domain to the next, and that information can be used to create intelligent pathways that automatically link activity between the two domains.

Referring to FIG. 3, one implementation of pathway visualization includes representing each page or page visit as a circular orb or node and the containing pathway as a colored line connecting them. This pathway can be displayed within a containing bar (“pathway bar”), oriented along the side of every open tab within the user's web browser. With each page visit, a node representing the new page is added to the pathway to represent forward movement through the network. Each node can also be signified with an identifying icon, image, or other representation, for example a website's favicon, to make the underlying page distinguishable to the user at-a-glance.

Referring to FIG. 4, hovering over a node can open an information box containing data about the page, including page title and URL, in addition to meta-data, as described above, related to the user's visit. An information box can also be provided that shows information about the pathway itself, such as who created the pathway, and how highly ranked the pathway creator is, based on, e.g., content, quality of content, the extent the pathway has been shared, or other implicit or explicit characteristics, such as the votes of other users.

A user can also perform additional actions on each node, including adding annotation and commentary and sharing the page via email or social network to specified recipients, where applicable. The pathway bar can also contain application-level action buttons. For example, and referring to FIG. 5, one key action button can open a dashboard interface containing all of the user's historical pathways and visits. From within this interface, a user can manipulate historical pathways, revisit or reopen historical pathways, share entire pathways by methods similar to those described above, perform textual searches of page content, and filter history by the meta-data attached to each page visit. In some instances, users can also modify and manipulate historically recorded pathways by, for example, deleting visits from within a pathway, rearranging the visit order within a pathway, naming a pathway, deleting a pathway, and merging two or more pathways.

In certain implementations, browsing data is linked to external data sources, and thus provides a much richer, contextual history browsing that more closely reflects how users naturally recall information. Using similar mechanisms as described above, when the application 106 is installed, page visits are captured using both browser listeners and scripts injected into a given page that are then sent to the server 110. Within the browser, the application 106 captures the timestamp of each page visit along with geolocation information, such as the user's latitude and longitude from APIs that the browser exposes.

This data is then relayed to the server 110, which connects to or otherwise accesses other data repositories that have been created using data from open APIs and other mechanisms such as page scraping. The server 110 can then reconciles this information gathered from external sources with the time and location provided by the user's browser along with other user-provided information (interests, other people present, etc.) to paint a more sensory picture of that user's page visit context. For example, time and location data can be used to fetch data from the national weather service, which is then be used to correlate the weather at the time of a page visit. Additionally, this information can be used to determine proximity to other users of the application or friends of a user on other location-aware social networks such as Foursquare and Facebook. Furthermore this page visit data can be reconciled with relevant current events in a given area that provide additional information as to what was going on in the area at the time when a user visited a page.

Referring to FIG. 6, the augmented data points (e.g., weather, proximity to other people, current events, personal events, etc.) can be stored on the server 110 and sent back to the application 106. Once received, the application 106 facilitates searching and filtering of browser history by these contextual data points. Additionally, the application 106 can use this contextual data to improve the pathway reconciliation described above, as well as recommend pathways and pages that the user may be interested in visiting in the future.

FIG. 7 illustrates one example of an interface 700 that a user can interact with in order to create and edit pathways. The interface 700 includes a route editing panel 710 through which the user can add individual webpages to a pathway. As shown in the route editing panel, the current pathway includes two webpages (“Webpage 1” and “Webpage 2”), and an option exists to add further pages (“Add a page”). Upon selecting the “Add a page” option, the user can be prompted to enter a page URL or other resource identifier, as well as add an accompanying image and/or description for the page. The new page can be inserted into any location in the route, and individual pages or groups of pages can be moved to different sections in the route by, for example, dragging and dropping. Pages can be deleted from the route by, for example, clicking the “x” button next to the page name. The interface 700 further includes route visualization panel 720, in which individual pages in the current pathway can be rendered or otherwise previewed to the editing user. As with the editing panel 710, routes can be manipulated via the visualization panel 720 by, for example, moving individual pages around in the pathway, deleting pages, browsing the visualized pathway by scrolling, and so on.

In some implementations, the various forms of information collected (user state, user action, user profile, content source, contextual, feedback, etc.) can be used for facilitating the provision or targeting of advertisements to users. Because the system is able to determine user intent, and thereby predict which pages a user is likely to traverse, relevant advertisements can be served to the user in early stages of the user's browsing. For example, returning again to the influenza example, the system knows that the user is interested in flu symptoms, but also learns, as the user continues to browse, that the user's ultimate likely intent is to search out a physician in his area if he believes he has the flu. Thus, the system can provide this information to interested advertisers, whether directly or via an offline or real-time bidding auction system and, as a result, an advertisement for a local physician can be served to the user in a preferable location in the user's browsing activity. The advertisement can be served, for example, on a particular webpage, in a window or frame created by the application 106, and/or as an interstitial advertisement between two or more webpages in the pathway that the user is browsing. Collected information can also be bundled with user-identifying data, such as an IP address, and sold to advertisers for targeted advertising within or independent from pathway browsing.

In other implementations, pathways can include branded or sponsored content, or a pathway itself can be branded or sponsored. For example, Mercedes-Benz can create and sponsor a pathway that includes both non-branded content (e.g., articles on the history of car manufacturing) as well as branded content (e.g., video commercials for the sale of Mercedes-Benz vehicles). Pathways can also include affiliate links such that certain parties can receive compensation when a user browses to a particular page in a pathway.

Implementations of the system described herein can use appropriate hardware or software; for example, the system can execute on hardware capable of running an operating system such as the Microsoft Windows® operating systems, the Apple OS X® operating systems, the Apple iOS® platform, the Google Android™ platform, the Linux® operating system and other variants of UNIX® operating systems, and the like.

Some or all of the functionality described herein can be implemented in software and/or hardware on a user's device 102. A user device 102 can include, but is not limited to, a smart phone, smart watch, smart glasses, tablet computer, portable computer, television, gaming device, music player, mobile telephone, laptop, palmtop, smart or dumb terminal, network computer, personal digital assistant, wireless device, information appliance, workstation, minicomputer, mainframe computer, or other computing device, that is operated as a general purpose computer or a special purpose hardware device that can execute the functionality described herein. The software, for example, can be implemented on a general purpose computing device in the form of a computer including a processing unit, a system memory, and a system bus that couples various system components including the system memory to the processing unit.

Additionally or alternatively, some or all of the functionality can be performed remotely, in the cloud, or via software-as-a-service. For example, as described above, certain functions can be performed on one or more remote servers 110 or other devices, as described above, that communicate with the user devices 102. The remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

A communications network can connect user devices 102 with one or more remote servers 110 and/or with each other. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are possible. The network can carry TCP/IP protocol communications, and HTTP/HTTPS requests made by a web browser, and the connection between the user devices 102 and servers 110 can be communicated over such TCP/IP networks. Other communication protocols are possible.

In various implementations, a user device 102 includes a web browser, native application, or both, that facilitates execution of the functionality described herein. A web browser allows the device to request a web page or other downloadable program, applet, or document (e.g., from the remote server(s) 110 or other server, such as a web server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the device 102 manually requests a web page from the server. Alternatively, the device 102 automatically makes requests with the web browser. Examples of commercially available web browser software include Microsoft® Internet Explorer®, Mozilla® Firefox®, and Apple® Safari®.

In some implementations, the user devices 102 include client software. The client software provides functionality to the device that provides for the implementation and execution of the features described herein. The client software can be implemented in various forms, for example, it can be in the form of a native application, web page, widget, and/or Java, JavaScript, .Net, Silverlight, Flash, and/or other applet or plug-in that is downloaded to the device and runs in conjunction with the web browser. The client software and the web browser can be part of a single client-server interface; for example, the client software can be implemented as a plug-in to the web browser or to another framework or operating system. Other suitable client software architecture, including but not limited to widget frameworks and applet technology can also be employed with the client software.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

In some cases, relational or other structured databases can provide such functionality, for example, as a database management system which stores data for processing. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method comprising:
receiving an indication that a user has visited a webpage;
predicting, using a predictive model, a plurality of webpages that are likely to be visited by the user, the prediction based at least in part on information associated with the visit to the webpage; and
providing a subset of the predicted webpages to the user as a traversable pathway of webpages.

2. The method of claim 1, wherein predicting the webpages that are likely to be visited by the user comprises determining an intent of the user based on the information associated with the visit to the webpage.

3. The method of claim 1, wherein the information associated with the visit to the webpage comprises at least one of: content of the visited webpage, a URL of the visited webpage, a link graph related to the visited webpage, a publisher associated with the visited webpage, and an author associated with the visited webpage.

4. The method of claim 1, wherein the information associated with the visit to the webpage comprises at least one of: a demographic of the user, a geolocation of the user, a behavior pattern of the user, a preference of the user, and social networking information associated with the user.

5. The method of claim 1, wherein the information associated with the visit to the webpage comprises at least one of: open browser tabs, previous webpages visited, webpages the user is likely to visit, and a pathway to the visited webpage.

6. The method of claim 1, wherein the information associated with the visit to the webpage comprises at least one of: a user action on the visited webpage, a user action with respect to the pathway, a duration of a user action on the visited webpage, and a duration of a user action with respect to the pathway.

7. The method of claim 1, wherein the information associated with the visit to the webpage comprises at least one of: a current date, a current time, nearby or tethered devices to a device of the user, active applications on a device of the user, current weather, a current event, and a calendar event.

8. The method of claim 1, wherein providing the subset of predicted webpages comprises ranking, using a ranking model, the webpages that are likely to be of interest to the user, and wherein the subset of predicted webpages comprises webpages that are highly ranked based on the ranking model.

9. The method of claim 1, wherein the pathway comprises a plurality of webpages relating to a topic of interest to the user.

10. The method of claim 1, wherein the pathway comprises a set of webpages preselected by another user.

11. The method of claim 1, wherein the pathway comprises a set of webpages automatically selected based at least in part on the information associated with the visit to the webpage.

12. The method of claim 1, further comprising crawling a plurality of webpages, and wherein the prediction is further based at least in part on information associated with the crawled webpages.

13. The method of claim 1, further comprising facilitating the provision of an advertisement to the user based on one or more of the webpages that are likely to be visited by the user.

14. The method of claim 13, wherein the advertisement is provided to the user in the course of a traversal of the pathway by the user.

15. A system comprising:
one or more computers programmed to perform operations comprising:
receiving an indication that a user has visited a webpage;
predicting, using a predictive model, a plurality of webpages that are likely to be visited by the user, the prediction based at least in part on information associated with the visit to the webpage; and
providing a subset of the predicted webpages to the user as a traversable pathway of webpages.

16. The system of claim 15, wherein predicting the webpages that are likely to be visited by the user comprises determining an intent of the user based on the information associated with the visit to the webpage.

17. The system of claim 15, wherein the information associated with the visit to the webpage comprises at least one of: content of the visited webpage, a URL of the visited webpage, a link graph related to the visited webpage, a publisher associated with the visited webpage, and an author associated with the visited webpage.

18. The system of claim 15, wherein the information associated with the visit to the webpage comprises at least one of: a demographic of the user, a geolocation of the user, a behavior pattern of the user, a preference of the user, and social networking information associated with the user.

19. The system of claim 15, wherein the information associated with the visit to the webpage comprises at least one of: open browser tabs, previous webpages visited, webpages the user is likely to visit, and a pathway to the visited webpage.

20. The system of claim 15, wherein the information associated with the visit to the webpage comprises at least one of: a user action on the visited webpage, a user action with respect to the pathway, a duration of a user action on the visited webpage, and a duration of a user action with respect to the pathway.

21. The system of claim 15, wherein the information associated with the visit to the webpage comprises at least one of: a current date, a current time, nearby or tethered devices to a device of the user, active applications on a device of the user, current weather, a current event, and a calendar event.

22. The system of claim 15, wherein providing the subset of predicted webpages comprises ranking, using a ranking model, the webpages that are likely to be of interest to the user, and wherein the subset of predicted webpages comprises webpages that are highly ranked based on the ranking model.

23. The system of claim 15, wherein the pathway comprises a plurality of webpages relating to a topic of interest to the user.

24. The system of claim 15, wherein the pathway comprises a set of webpages preselected by another user.

25. The system of claim 15, wherein the pathway comprises a set of webpages automatically selected based at least in part on the information associated with the visit to the webpage.

26. The system of claim 15, wherein the operations further comprise crawling a plurality of webpages, and wherein the prediction is further based at least in part on information associated with the crawled webpages.

27. The system of claim 15, wherein the operations further comprise facilitating the provision of an advertisement to the user based on one or more of the webpages that are likely to be visited by the user.

28. The system of claim 27, wherein the advertisement is provided to the user in the course of a traversal of the pathway by the user.
